(19) United States
(12) Patent Application Publication
(10) Pub. No.: US 2010/0039814 A1
(43) Pub. Date: Feb. 18, 2010

(54) LED REFLECTOR AND A LAMP INCLUDING THE SAME

(76) Inventor: Steve Germain, Quebec (CA)

Correspondence Address: FAY SHARPE LLP, 1228 Euclid Avenue, 5th Floor, The Halle Building, Cleveland, OH, 44115, US

(21) Appl. No.: 12/191,104

(22) Filed: Aug. 13, 2008

(51) Int. Cl. F21V 7/00; F21V 21/00

(52) U.S. Cl. 362/247; 362/346; 362/249.07

(57) ABSTRACT

A lamp includes a support, a plurality of LEDs mounted on the support, and a reflector connected with the support. The reflector includes a plurality of interconnected reflector cups each including an LED opening that receives a respective LED. The reflector also defines at least one void disposed between adjacent reflector cups for allowing light from outside the lamp that enters the lamp to pass through the void so as not to be reflected by the reflector.

### BACKGROUND

LED traffic signal lamps attempt to collimate light to direct the light generated by LEDs found in the signal towards the viewer of the signal. LED signal lamps that employ a collimating lens are especially susceptible to the “sun phantom” effect. The “sun phantom” effect is where sunlight reflecting off of internal components of the LED signal results in the LED signal appearing as “on.” Known LED signals that employ a reflector having multiple reflector cups create a large reflective surface area so that light coming from outside the LED signal, typically from the sun, reflects on this reflective surface and bounces back to the outside of the lamp, thus creating a “sun phantom” effect when the lamp is not meant to be illuminated.

LED signals that employ reflectors including multiple reflector cups typically cover the front surface of the printed circuit board upon which the LEDs are mounted. This prevents heat that is generated from the LED from dissipating in the ambient air that is in front of the printed circuit board. This can result in the LEDs having a shorter life as compared to LEDs that operate in a cooler environment.

### SUMMARY

A lamp that overcomes the aforementioned shortcomings includes a support, a plurality of LEDs mounted on the support, and a reflector connected with the support. The reflector includes a plurality of interconnected reflector cups each including an LED opening that receives a respective LED. The reflector also defines at least one void disposed between adjacent reflector cups for allowing light from outside the lamp that enters the lamp to pass through the void so as not to be reflected by the reflector.

The reflector can include a plurality of ribs connected with the reflector cups. The reflector can include an annular support connected with the ribs. Alternatively, the reflector can include at least two annular supports connected with the ribs. The reflector cups can form a symmetrical pattern. The symmetrical pattern can be symmetrical about at least two mutually perpendicular axes. The lamp can further include a layer disposed on the support where the layer has a reflectance that is lower than a reflectance of a reflective surface of the reflector cups.

A reflector for use in an LED lamp that overcomes the aforementioned shortcomings includes a plurality of interconnected reflector cups. Each reflector cup includes an opening for receiving an LED. At least two adjacent reflector cups define a void therebetween.

The reflector can be a single molded piece. The reflector can be plastic that is coated with a specular material in the reflector cups. The reflector can further included an annular structure connected with the plurality of reflector cups. The reflector can further include a plurality of ribs connected with the annular structure and the reflector cups. The reflector can further include fastener receiving regions connected with the annular structure. The reflector can be symmetrical about at least two mutually perpendicular axes.

An example of an LED signal that overcomes the aforementioned shortcomings includes a housing, a transparent cover, a support, LEDs, and a reflector. The housing includes an opening. The transparent cover connects to the housing covering the opening. The support is disposed in the housing. The LEDs are on the support. The reflector connects with the support and is disposed in the housing. The reflector includes a plurality of interconnected reflector cups each including an LED opening that receives a respective LED and a plurality of interconnected ribs. Some of the ribs terminate at a respective reflector cup.

The signal can further include at least one annular structure and some of the ribs can terminate at the at least one annular structure. The at least one annular structure can include first and second annular structures and some of the ribs can interconnect the annular structures. An outer edge of the reflector with respect to the support can define a generally concave surface. The reflector can be devoid of material between adjacent ribs. The reflector can be made from a single piece of material.

### BRIEF DESCRIPTION OF THE DRAWINGS

FIG. 1 is an exploded view of an LED signal lamp.

FIG. 2 is a perspective view of a reflector for the LED signal lamp shown in FIG. 1.

FIG. 3 is a plan view of the reflector shown in FIG. 2.

FIG. 4 is a plan view of an alternative embodiment of a reflector for an LED signal lamp.

FIG. 5 is a perspective view of another alternative embodiment of a reflector for use in an LED signal lamp, depicting the reflector connected to a printed circuit board having LEDs disposed on the board.

FIG. 6 is a perspective view of another alternative embodiment of a reflector for use in an LED signal lamp, depicting the reflector connected to a printed circuit board having LEDs disposed on the board.

FIG. 7 is another alternative embodiment of a reflector for use in an LED signal lamp, depicting the reflector connected to a printed circuit board having LEDs disposed on the board.

FIG. 8 is a schematic depiction of a side view of the reflectors shown in FIG. 6 and FIG. 7.

### DETAILED DESCRIPTION

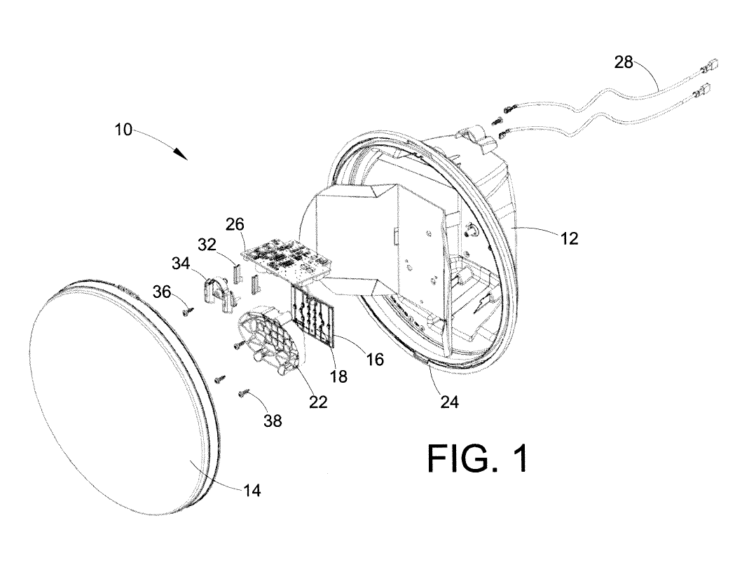

With reference to FIG. 1, a light emitting diode (LED) traffic signal 10 includes a housing 12, a transparent cover 14 connected to the housing, a support 16 disposed in the housing, LEDs 18 on the support and a reflector 22 also disposed in the housing. The housing includes an opening 24 and the transparent cover 14 connects to the housing to cover the opening. Other optical elements, such as a multiple collimating zone element, diffusing optical elements and the like can also be provided adjacent the transparent cover. Such optical elements cooperate with the LEDs to direct the light and are known in the art. The optical components (including the transparent cover 14) can be configured to collimate light from the LEDs 18.

The lamp 10 also includes an additional circuit board 26 having electrical components thereon that condition electrical power received from wires 28 that are connected to an external power source. Electrical connectors 32 connect to the additional circuit board 26 to electrically connect the wires 28 to the circuit board. A connector cover 34 covers the electrical connectors 32. A fastener 36 is provided to connect the electrical cover 34 in the housing 12. Fasteners 38 are also provided to connect the reflector 22 and the support 16, which in the illustrated embodiment is a printed circuit board (“PCB”), in the housing 12. The connector cover 34 and the reflector 22 can be connected in the housing in other conventional manners.

The “sun phantom” effect can be created from surfaces of the transparent cover 14, or other surfaces of optical components behind the transparent cover (not shown), directing incoming sunlight towards the LEDs 18 and the reflector 22. The sunlight can reflect back towards the viewer of the LED traffic signal 10 to appear that the traffic signal is “on.”

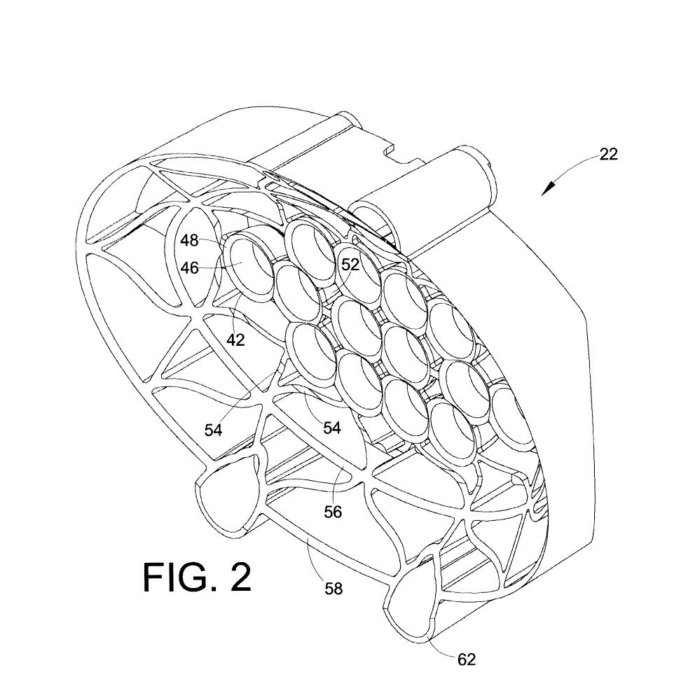

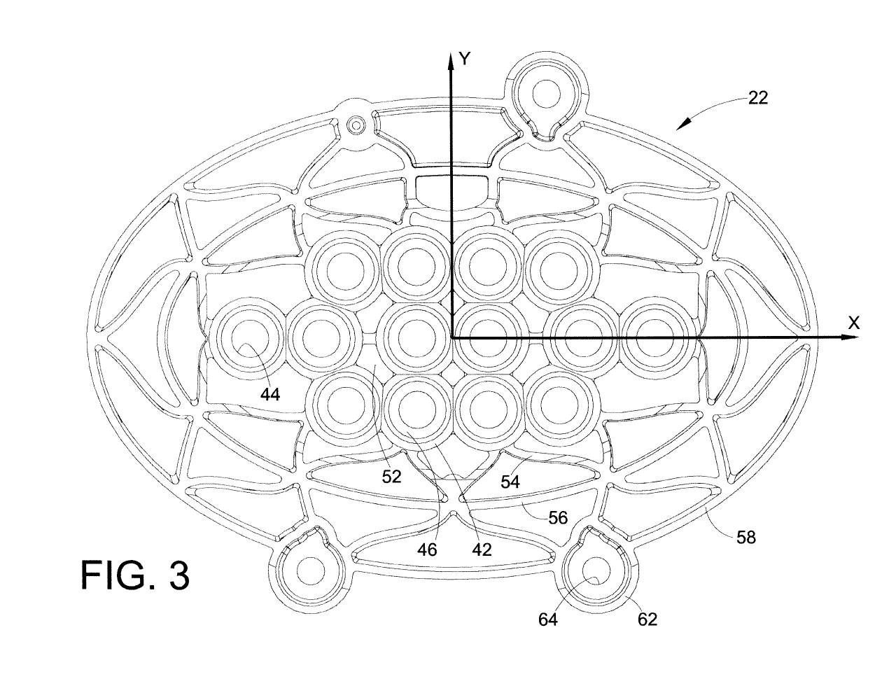

With reference to FIG. 2, the reflector 22 is designed to mitigate the “sun phantom” effect and can also help with the heat dissipation of the heat generated by the LEDs 18 (FIG. 1). As shown in FIG. 1, the reflector 22 connects with the PCB 16, which acts as a support for the LEDs 18. With reference back to FIG. 2, the reflector 22 includes a plurality of interconnected reflector cups 42 each including an LED opening 44 (FIG. 3) that receives a respective LED 18 (FIG. 1). As more clearly seen in FIG. 3, the reflector cups 42 form a symmetrical pattern. The symmetrical pattern can be symmetrical about two mutually perpendicular axes (X and Y axes in FIG. 3).

Each reflector cup 42 can include a reflective surface 46. The reflective surface can be formed by a specular, or substantially specular, coating or film placed around the LED opening 44 up to an upper edge 48 of each reflector cup. The reflective surface can be a parabolloid or other shape to direct the light emanating from the LEDs to form a desired beam pattern. The reflector 22 can also be made from a specular material, e.g., aluminum. The reflector 22 defines at least one void 52 disposed between adjacent reflector cups. The voids allow light from outside the lamp, e.g., sunlight that enters the lamp, to pass through the void 52 so as not to be reflected by the reflector 22.

The reflector 22 also includes a plurality of ribs 54 connected with the reflector cups 42. In the depicted embodiment, annular supports connect with the ribs 54: an inner annular support 56 and an outer annular support 58. The annular supports 56 and 58 are shown as elliptical in plan view (FIG. 3); however, the annular supports 56 can take other annular configurations, for example circular or rectangular. Fastener receiving regions 62 connect with the outer annular support 58. These fasteners receiving regions can be located elsewhere in the reflector. Each fastener receiving region 62 includes a fastener opening 64 (FIG. 3) that receives a fastener 38 (FIG. 1) to attach the reflector 22 and the PCB 16 in the housing 12. The reflector 22 can attach inside the housing 12 in other known manners. Some ribs 54 interconnect the reflector cups 42 to the inner annular structure 56 and some ribs connect the inner annular structure 56 to the outer annular structure 58. Each of the ribs 54 have the same thickness and each has a constant thickness from a bottom or inner edge (edge facing or adjacent the PCB 16) to a top or outer edge. As more clearly seen in FIG. 2, the top or outer edge of the reflector defines a generally concave surface. The bottom or lower edge of the reflector is flat or generally planar.

In the depicted embodiment, the reflector 22 is a single molded piece of plastic. The reflective surfaces 46 are coated with a substantially specular material. The entire reflector 22 can be coated with a similar specular material. It can be desirable to have the surfaces of the reflector other than the reflective surfaces 46 to not be as reflective as the reflector surfaces 46. These other surfaces can be covered with a black matte finish. The interior of the housing 12 can be a dark, e.g., black matte surface that poorly reflects light. Additionally, a layer can be disposed on the PCB 16 that has a reflectance that is lower than the reflectance of the reflective surface 46 of the reflector cups 42. Such a coating on the PCB can be a black matte finish.

The reflector 22 and the ribs 54 and annular structures 56,58 provide a reduction of the surface area of the reflector while maintaining good structural stiffness so that the reflector will not deform with the heat generated by the LEDs 18. By reducing the surface area of the PCB 16 that is hidden by the reflector 22, heat dissipation from the LEDs 18 on the PCB 16 can be enhanced since the reflector 22 is devoid of material between adjacent ribs. This can create holes or voids in the reflector 22 to allow heat to escape from the top or front of the PCB 16 toward the ambient air in front of the LEDs 18. This results in heat dissipation via convection. By aiding in the heat dissipation of the LEDs 18, a reduction of the temperature of the LED can result in an increase in light output which makes it possible to reduce the number of LEDs for the same application. Fewer higher powered LEDs can be used as compared to conventional designs.

The reduction of the front surface area of the reflector 22 also reduces the surface area where light coming from outside the lamp can reflect thus creating the “sun phantom” effect. Again, any light that travels in the voids 52 between adjacent reflector cups 42 or between the ribs 54 and the annular structures 56 and 58 where the reflector is devoid of material, this light contacts the printed circuit board or other dark surface in the housing 12 which can have the black matte finish. After impinging upon the dark surface, the light is not redirected outwardly causing the “sun phantom” effect. Moreover the height of the ribs 54 and that the top or outer edge of the ribs and the annular structures 56 and 58 extends above the top or outer edge of the reflector cups 42 further reduces the sun phantom effect. The concavity of the top surface of the reflector 22 provides an unimpeded path for light from the LEDs 18 out of the reflector 22, but incoming light that impinges upon the PCB 16 in the area of the voids 52 can contact the sides of the ribs 54 or the annular structures 56, 58 and be absorbed or redirected toward another component inside the lamp having a black matte finish. The “sun phantom” effect can be reduced without having to mask portions of the reflector during the coating process by which the specular coating is deposited on the reflective surfaces 44 of the reflective cups 42. This results in a more economical reflector 22 and LED traffic signal 10.

The reflector 22 can also be made from a thermally conductive material e.g., aluminum, or thermally conductive plastic. If the reflector were made from a reflective enough material, additional coating of the reflective surfaces may not be necessary.

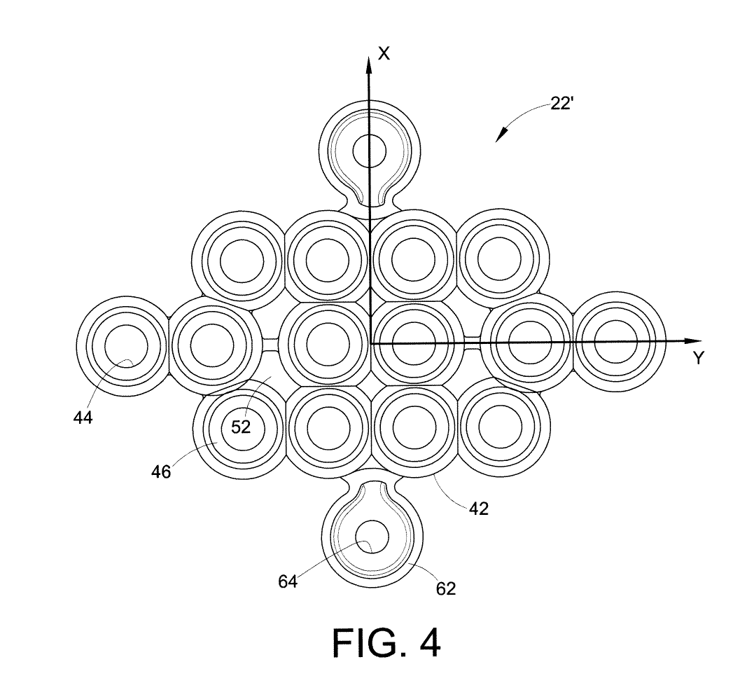

With reference to FIG. 4, an alternative embodiment of a reflector 22′ is shown. This reflector can be a single molded piece of plastic. Similar to the reflector 22 described above, this reflector 22′ can connect with the PCB 16 and also includes a plurality of interconnected reflector cups 42 each including an LED opening 44 that receives a respective LED 18. The reflector cups can form a symmetrical pattern that can be symmetrical about to mutually perpendicular axes (x and y axes in FIG. 4). The configuration of the reflector 22′ is very similar to the configuration of the reflector 22 described above, but does not include the ribs and the annular structure that was described above. Accordingly, reflective surfaces 46 can be formed of a substantially specular coating or film placed around the LED opening 44 up to an upper edge of each reflector cup. The reflective surface can be a parabolloid or other shape to direct light emanating from the LEDs to form a desired beam pattern. The reflector can be made of aluminum or thermally conductive plastic. The reflector 22′ defines at least one void 52 disposed between adjacent reflector cups, which allows light from outside the lamp, e.g., sunlight that enters the lamp, to pass through the void so as not to be reflected by the reflector. The reflector 22′ can also include fastener receiving regions 62 that connect to a respective reflector cup. Each fastener receiving region 62 includes a fastener opening 64 that receives a fastener to attach the reflector and the PCB 16 in the housing 12 (FIG. 1).

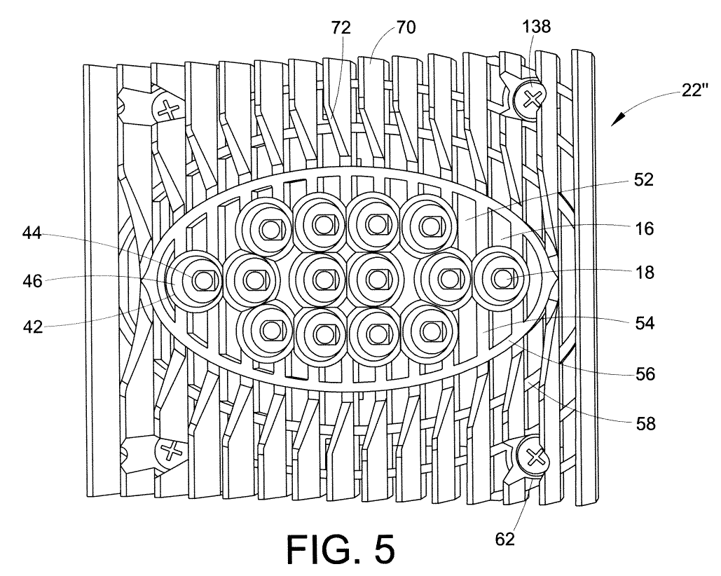

FIG. 5 depicts an alternative embodiment of a reflector 22″ designed to mitigate the “sun phantom” effect and that can also facilitate heat dissipation of the heat generated by the LEDs 18. The reflector 22″ includes a plurality of interconnected reflector cups 42 each including an LED opening 44 that receives a respective LED 18. The reflector cups 42 in the embodiment also form a symmetrical pattern, which can be symmetrical about two mutually perpendicular axes.

Each reflector cup 42 includes a reflective surface 46. The reflective surface 46 is formed by a substantially specular coating or film placed around the LED opening 44 up to an upper edge of each reflector cup. The reflector defines at least one void 52 that is disposed between adjacent reflector cups. The voids allow light from outside the lamp to pass through the void 52 onto a black matte finish that is deposited on the PCB 16.

The reflector 22″ also includes a plurality of ribs 54 connected with the reflector cups 42. Different than the embodiments shown above, the ribs 54 extend away from the printed circuit board 16 to form heat sink fins 70. An inner annular support 56 and an outer annular support 58, which are elliptical in plan view, are connected to the ribs 54. Fastener receiving regions 62 connect with the ribs 54 and the heat sink fins 70. Each fastener receiving region 62 includes an opening (not visible) that received fasteners 38 to attach the reflector 22″ and the PCB 16 and the housing 12.

In the depicted embodiment, the heat sink fins 70 extend upwardly from the ribs 54 only at locations radially outside the inner annular support 56. Each heat sink fin 70 includes an inner radial edge 72 that slopes upwardly and radially outwardly from the inner annular support 56. This maximizes the surface area of the heat sink fin 70 while also allowing light emanating from the LEDs to not be blocked by the heat sink fins. Each of the ribs 54 and the heat sink fins 70 have the same thickness and each has a substantially constant thickness from a bottom or inner edge to a top or outer edge. The inner radial surface 72 of the heat sink fins 70 and the outer or upper edge of the inner annular support 56 and the ribs 54 define a generally concave surface (similar to the reflector 22 in FIG. 2). The reflector 22″ can be a single molded piece of plastic, which can also be a thermally conductive plastic. It is desirable to provide a thermally conductive plastic to dissipate more heat from the LEDs. Moreover, the reflector 22″ can be made from a conductive metal, such as aluminum.

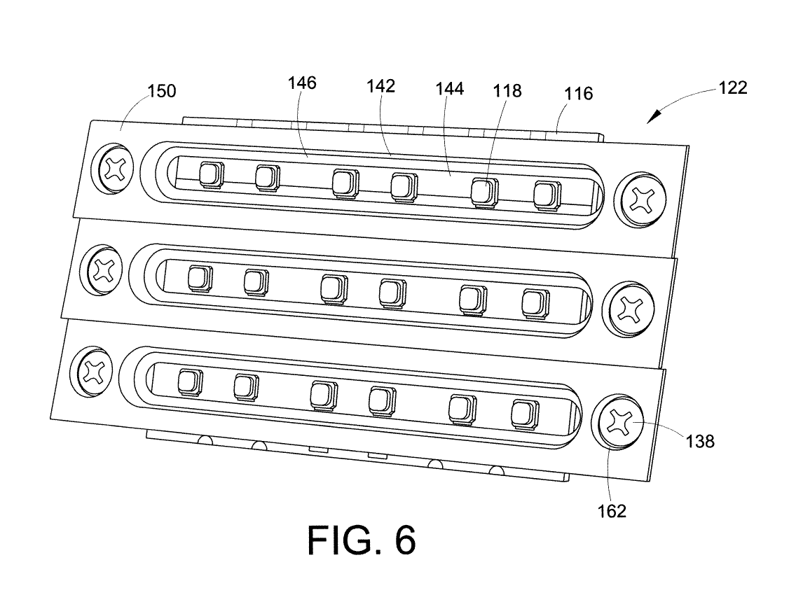

With reference to FIG. 6, a PCB 116, LEDs 118 and a reflector 122, which can be installed in a traffic signal, such as the traffic signal 10 shown in FIG. 1, is shown. The reflector 122 includes a plurality of interconnected reflector cups 142 each including an LED opening 144. Each LED opening 144 in the embodiment depicted in FIG. 6 receives a plurality of LEDs 118. The reflector cups 142 can form a symmetrical pattern, which in the illustrated embodiment is symmetrical about two mutually perpendicular axes. Each reflector cup 142 can include a reflective surface 146, which can be substantially specular. The reflector 122 also includes a substantially planar surface 150 at an upper or outermost edge of each reflector cup 142. This planar surface 150 can be covered with a film or coating that is not as reflective as the reflective surface 146, such as a black matte finish. With reference to FIG. 8, the reflector 122 also defines at least one void 152 disposed between adjacent reflector cups. This void 152 can help with heat dissipation by allowing heated air to escape from the printed circuit board 116 through the void 152. The reflector 122 also includes fastener receiving regions 162 that receive fasteners 138 to connect the reflector 122, the printed circuit board 116 and the LEDs 118 within the housing of an LED signal lamp.

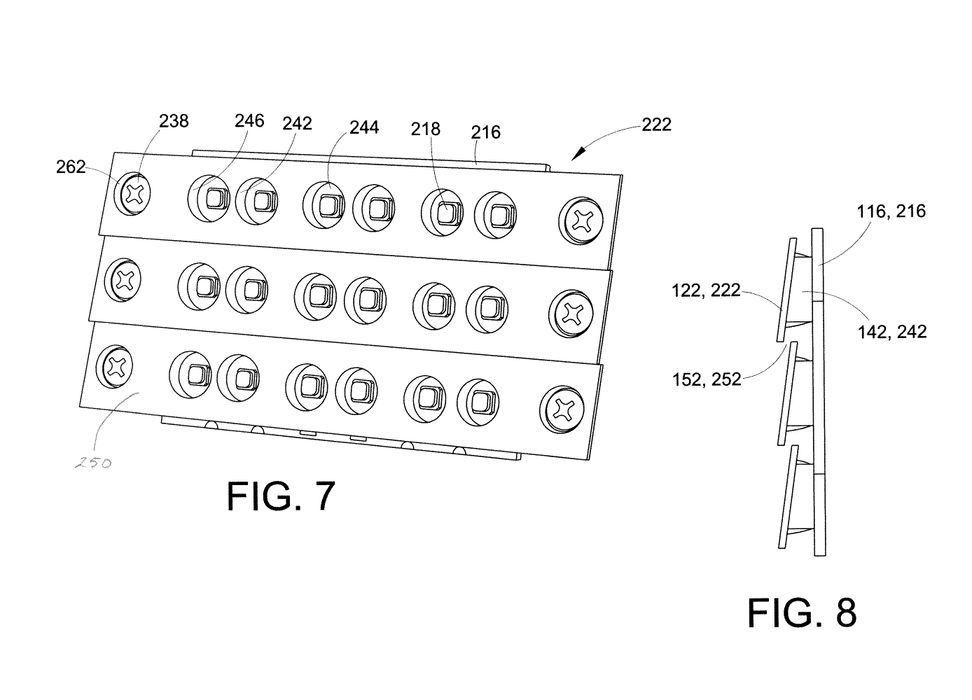

With reference to FIG. 7, an alternative embodiment of a reflector 222 is shown. The reflector 222, the PCB 116 and the LEDs 218 can be disposed in the housing 12 of an LED signal lamp 10 shown in FIG. 1. The reflector 222 includes a plurality of interconnected reflector cups 242 each including an LED opening 244. Each LED opening 244 in the embodiment depicted in FIG. 7, receives a single LED 218. The reflector cups 242 can form a symmetrical pattern, which is symmetrical about two mutually perpendicular axes. Each reflector cup 242 includes a reflective surface 246, which can be substantially specular. The reflector 222 also includes a substantially planar surface 250 at an upper or outermost edge of each reflector cup 242. This planar surface 250 can be covered with a film or coating that is not as reflective as the reflective surface, such as a black matte finish.

With reference to FIG. 8, the reflector 222 also defines at least one void 252 disposed between adjacent reflector cups. This void 252 can help with heat dissipation by allowing heated air to escape from the printed circuit board 216 through the void 252. The reflector 222 also includes fastener receiving regions 262 that receive fasteners 238 to connect the reflector 222, the printed circuit board 216 and the LEDs 218 within the housing of an LED signal lamp.

Even though the reflector has been described with reference to an LED lamp signal, the reflector can be used in other LED lamps. Moreover, only specific embodiments have been described above. The invention, however, is not limited to only the embodiments described above. Instead, the invention should be construed to include all modifications and alterations that come within the scope of the appended claims and the equivalents thereof.

1. A lamp comprising:
a support;
a plurality of LEDs mounted on the support;
a reflector connected with the support and including a plurality of interconnected reflector cups each including an LED opening that receives a respective LED, the reflector also defining at least one void disposed between adjacent reflector cups.

2. The lamp of claim 1, wherein the reflector includes a plurality of ribs connected with the reflector cups.

3. The lamp of claim 2, wherein the reflector includes an annular support connected with the ribs.

4. The lamp of claim 2, wherein the reflector includes at least two annular supports connected with the ribs.

5. The lamp of claim 1, wherein the reflector cups form a symmetrical pattern.

6. The lamp of claim 1, further comprising at least one optical element disposed in front of the LEDs.

7. The lamp of claim 6, wherein the at least one optical element includes a collimating element or a diffusing element.

8. The lamp of claim 1, further comprising a layer disposed on the support, the layer having a reflectance that is lower than a reflectance of a reflective surface of the reflector cups.

9. The lamp of claim 1, wherein each LED opening receives a single LED.

10. The lamp of claim 1, wherein each LED opening receives at least two LEDs.

11. A reflector for use in an LED lamp, the reflector comprising a plurality of interconnected reflector cups, each reflector cup including an opening for receiving an LED, at least two adjacent reflector cups defining a void therebetween.

12. The reflector of claim 11 being a single piece of material.

13. The reflector of claim 12, wherein the reflector is molded plastic coated with a substantially specular material in the reflector cups.

14. The reflector of claim 11, further comprising an annular structure connected with the plurality of reflector cups.

15. The reflector of claim 14, further comprising a plurality of ribs connected with the annular structure and the reflector cups.

16. The reflector of claim 16, further comprising fastener receiving regions connected with the annular structure.

17. The reflector of claim 11 being symmetrical about at least two mutually perpendicular axes.

18. A signal comprising:
a housing including an opening;
a transparent cover connected to the housing covering the opening;
a support disposed in the housing;
LEDs on the support;
a reflector connected with the support and disposed in the housing, the reflector including a plurality of interconnected reflector cups each including an LED opening that receives a respective LED and a plurality of interconnected ribs, some of the ribs terminating at a respective reflector cup.

19. The signal of claim 18 further comprising at least one annular structure, some of the ribs terminating at the at least one annular structure.

20. The signal of claim 19, wherein the at least one annular structure includes first and second annular structures, wherein some of the ribs interconnect the annular structures.

21. The signal of claim 17, wherein an outer edge of the reflector with respect to the support defines a generally concave surface.

22. The signal of claim 18, wherein the reflector is devoid of material between adjacent ribs.
